(19) United States
(12) Patent Application Publication
(10) Pub. No.: US 2026/0276013 A1
(43) Pub. Date: Sep. 17, 2026

(54) FIXING STRUCTURE

(71) Applicant: Jentech Precision Industrial Co., LTD., TAOYUAN CITY (TW)

(72) Inventors: Fang-Wei YANG, TAOYUAN CITY (TW); Hung-Yi WANG, TAOYUAN CITY (TW); Ping-Chi LIU, TAOYUAN CITY (TW); Po-Yuan SU, TAOYUAN CITY (TW); Chang-Chi YEH, TAOYUAN CITY (TW)

(21) Appl. No.: 19/299,320

(22) Filed: Aug. 13, 2025

(30) Foreign Application Priority Data
Mar. 17, 2025 (TW) 114109941

(51) Int. Cl. F16B 5/02; F16B 37/14

(52) U.S. Cl. CPC F16B 5/0258; F16B 5/0283; F16B 37/14

(57) ABSTRACT

A fixing structure includes a lower plate, an upper plate, an elastic structure, and a nut. The upper plate located over the lower plate. The elastic structure runs through the upper plate. The elastic structure includes an elastic portion, a bolt portion connected to an end of the elastic portion, and a screwing portion connected to the other end of the elastic portion. The elastic portion elastically stretches and compresses along a direction. The screwing portion is fixed to the lower plate and remains stationary relative to the lower plate. The nut is threadedly engaged with the bolt portion and abuts against a top surface of the upper plate. The nut rotates relative to a rotation axis parallel to the direction and drives the upper plate to move toward the lower plate. The elastic portion elastically stretches along the direction.

This application claims priority to Taiwan Application Serial Number 114109941, filed March 17, 2025, which is herein incorporated by reference in its entirety.

### BACKGROUND

### Field of Invention

The present invention relates to a fixing structure.

### Description of Related Art

In general, in the fields of computers and servers, a circuit board is typically provided with a plurality of core structures. These core structures are usually mounted on the circuit board and fixed thereto by fixing parts (e.g., screws). In some practical situations, the core structures are located between two circuit boards and are fixed by being clamped between the two circuit boards.

However, when the core structures located between the two circuit boards are further fixed by fixing parts, excessive rotation of the fixing parts by an operator may result in over-tightening, causing deformation of the two circuit boards or even damage to the core structures. In addition, due to the wide variety of computer or server models, the corresponding core structures also have various dimensions. The existing fixing methods for core structures cannot effectively adapt to core structures of different sizes.

Therefore, how to propose a fixing structure that can solve the aforementioned problems is one of the problems that the industry is currently eager to invest in research and development resources to solve.

### SUMMARY

In view of this, one purpose of the present disclosure is to provide a fixing structure that can solve the aforementioned problems.

In order to achieve the above objective, according to an embodiment of the present disclosure, a fixing structure includes a lower plate, an upper plate, an elastic structure, and a nut. The upper plate is located over the lower plate. The elastic structure runs through the upper plate. The elastic structure includes an elastic portion, a bolt portion connected to an end of the elastic portion, and a screwing portion connected to the other end of the elastic portion. The elastic portion elastically stretches and compresses along a direction. The screwing portion is fixed to the lower plate and remains stationary relative to the lower plate. The nut is threadedly engaged with the bolt portion and abuts against a top surface of the upper plate. The nut rotates relative to a rotation axis parallel to the direction and drives the upper plate to move toward the lower plate. The elastic portion elastically stretches along the direction.

In one or more embodiments of the present disclosure, the nut rotates relative to the rotation axis parallel to the direction and drives the upper plate to move away from the lower plate. The elastic portion elastically compresses along the direction.

In one or more embodiments of the present disclosure, the fixing structure further includes a fixing part threadedly engaged with the screwing portion.

In one or more embodiments of the present disclosure, the fixing structure further includes a sleeve sleeves the elastic structure. The sleeve includes a sleeve main body passing through the upper plate and a shoulder portion located at an end of the sleeve main body.

In one or more embodiments of the present disclosure, when the nut rotates relative to the rotation axis parallel to the direction such that the shoulder portion abuts against a bottom surface of the upper plate, the upper plate remains stationary relative to the lower plate.

In one or more embodiments of the present disclosure, the fixing structure further includes a spacing washer disposed between the upper plate and the shoulder portion.

In one or more embodiments of the present disclosure, when the nut rotates relative to the rotation axis parallel to the direction such that the spacing washer contacts the bottom surface of the upper plate and the shoulder portion, the upper plate remains stationary relative to the lower plate.

In one or more embodiments of the present disclosure, the elastic portion includes a first elastic portion and a second elastic portion connected to the first elastic portion. The first elastic portion is connected to the bolt portion. The second elastic portion is connected to the screwing portion.

In one or more embodiments of the present disclosure, the nut includes an inner thread threadedly engaged with the bolt portion and has an accommodating space accommodating the elastic portion.

In one or more embodiments of the present disclosure, when the nut rotates relative to the rotation axis parallel to the direction such that the first elastic portion abuts against an end of the accommodating space close to the inner thread, the upper plate remains stationary relative to the lower plate.

In one or more embodiments of the present disclosure, when the nut rotates relative to the rotation axis parallel to the direction and drives the upper plate to move toward the lower plate, the first elastic portion and the second elastic portion elastically stretch simultaneously.

In one or more embodiments of the present disclosure, the fixing structure further includes a sleeve sleeves the second elastic portion. The sleeve includes a sleeve main body passing through the upper plate and a shoulder portion located at an end of the sleeve main body.

In one or more embodiments of the present disclosure, the nut includes an inner thread threadedly engaged with the bolt portion and has an accommodating space accommodating the first elastic portion.

In one or more embodiments of the present disclosure, when the nut rotates relative to the rotation axis parallel to the direction such that the first elastic portion abuts against an end of the accommodating space close to the inner thread, the upper plate remains stationary relative to the lower plate.

In one or more embodiments of the present disclosure, when the nut rotates relative to the rotation axis parallel to the direction and the shoulder portion abuts against a bottom surface of the upper plate, the first elastic portion elastically stretches and the second elastic portion remains stationary.

In one or more embodiments of the present disclosure, when the nut rotates relative to the rotation axis parallel to the direction, the first elastic portion and the second elastic portion elastically stretch simultaneously and the sleeve moves toward the upper plate.

In order to achieve the above objective, according to an embodiment of the present disclosure, a fixing structure includes a lower plate, an upper plate, a core structure, an elastic structure, and a nut. The upper plate is located over the lower plate. The core structure is located between the upper plate and the lower plate. The elastic structure runs through the upper plate. The elastic structure includes an elastic portion, a bolt portion connected to an end of the elastic portion, and a screwing portion connected to the other end of the elastic portion. The elastic portion elastically stretches and compresses along a direction. The screwing portion is fixed to the lower plate and remains stationary relative to the lower plate. The nut is threadedly engaged with the bolt portion and abuts against a top surface of the upper plate. The nut rotates relative to a rotation axis parallel to the direction and drives the upper plate to move toward the lower plate. The elastic portion elastically stretches along the direction.

In one or more embodiments of the present disclosure, the fixing structure further includes a sleeve sleeves the elastic structure. The sleeve includes a sleeve main body passing through the upper plate and a shoulder portion located at an end of the sleeve main body.

In one or more embodiments of the present disclosure, the elastic portion includes a first elastic portion and a second elastic portion connected to the first elastic portion. The first elastic portion is connected to the bolt portion. The second elastic portion is connected to the screwing portion.

In one or more embodiments of the present disclosure, the fixing structure further includes a sleeve sleeves the second elastic portion. The sleeve includes a sleeve main body passing through the upper plate and a shoulder portion located at an end of the sleeve main body.

In summary, in the fixing structure of the present disclosure, since the nut is threadedly engaged with the bolt portion of the elastic structure and abuts against the top surface of the upper plate, the rotation of the nut relative to the bolt portion can drive the upper plate to move toward the lower plate, thereby allowing the upper plate and the lower plate to clamp the core structure. In the fixing structure of the present disclosure, since the elastic structure includes an elastic portion that elastically stretches along a direction, the elastic portion elastically stretches along the direction after the nut rotates relative to the bolt portion such that the upper plate and the lower plate clamp the core structure, thereby preventing deformation of the upper plate and the lower plate and damage to the core structure caused by over-tightening. In the fixing structure of the present disclosure, since the sleeve sleeves the elastic portion, the sleeve includes a sleeve main body and a shoulder portion located at an end of the sleeve main body, and the screwing portion of the elastic structure is fixed to the lower plate, the sleeve moves toward the nut along with the stretching of the elastic portion and the elastic portion stops stretching when the shoulder portion abuts against the bottom surface of the upper plate. In the fixing structure of the present disclosure, since the spacing washer is disposed between the shoulder portion and the upper plate, when the core structure has a greater length along the direction, more spacing washers may be disposed between the shoulder portion and the upper plate such that a constant amount of elastic stretching of the elastic portion can be maintained, thereby achieving the effect of prolonging the service life of the elastic structure. Overall, the fixing structure of the present disclosure can be used to fix core structures of various sizes between the upper plate and the lower plate, prevent deformation and damage caused by over-tightening, and extend the service life of the elastic structure.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 is a perspective view of a fixing structure in accordance with an embodiment of the present disclosure;

FIG. 2 is a cross-sectional view of a fixing structure in accordance with an embodiment of the present disclosure;

FIG. 3 is a cross-sectional view of a fixing structure in accordance with an embodiment of the present disclosure;

FIG. 4 is a perspective view of a fixing structure in accordance with an embodiment of the present disclosure;

FIG. 5 is a cross-sectional view of a fixing structure in accordance with an embodiment of the present disclosure;

FIG. 6 is a cross-sectional view of a fixing structure in accordance with an embodiment of the present disclosure;

FIG. 7 is a perspective view of a fixing structure in accordance with an embodiment of the present disclosure;

FIG. 8 is a cross-sectional view of a fixing structure in accordance with an embodiment of the present disclosure;

FIG. 9 is a cross-sectional view of a fixing structure in accordance with an embodiment of the present disclosure;

FIG. 10 is a perspective view of a fixing structure in accordance with an embodiment of the present disclosure;

FIG. 11 is a cross-sectional view of a fixing structure in accordance with an embodiment of the present disclosure; and

FIG. 12 is a cross-sectional view of a fixing structure in accordance with an embodiment of the present disclosure.

### DETAILED DESCRIPTION

Hereinafter, a plurality of embodiments of the present disclosure will be disclosed in diagrams. For the sake of clarity, many details in practice will be described in the following description. However, it should be understood that these details in practice should not limit present disclosure. In other words, in some embodiments of present disclosure, these details in practice are unnecessary. In addition, for simplicity of the drawings, some conventionally used structures and elements will be shown in a simple schematic manner in the drawings. The same reference numbers are used in the drawings and the description to refer to the same or like parts.

Hereinafter, the structure and function of each component included in a fixing structure 100 of this embodiment and the connection relationship between the components will be described in detail.

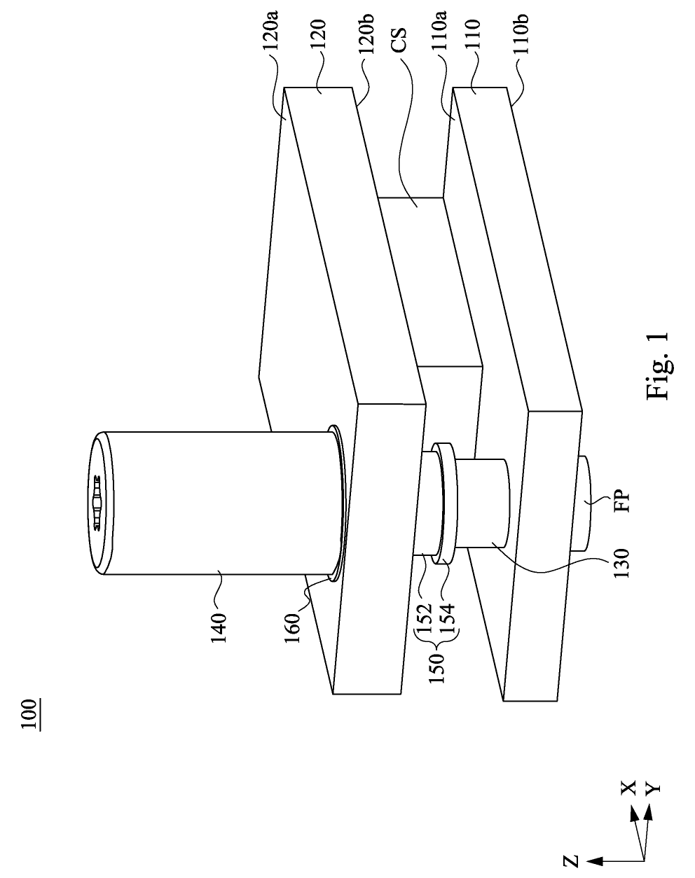

Reference is made to FIG. 1. FIG. 1 is a perspective view of a fixing structure 100 in accordance with an embodiment of the present disclosure. As shown in FIG. 1, in this embodiment, the fixing structure 100 is configured to fix a core structure CS. The fixing structure 100 includes a lower plate 110, an upper plate 120, an elastic structure 130, a nut 140, a sleeve 150, a sealing washer 160, and a fixing part FP. The lower plate 110 has a top surface 110a and a bottom surface 110b. The upper plate 120 has a top surface 120a and a bottom surface 120b. The upper plate 120 is located over the lower plate 110. The core structure CS is located between the upper plate 120 and the lower plate 110. The elastic structure 130 is connected between the lower plate 110 and the upper plate 120. The elastic structure 130 is configured to elastically stretches and compressed along a direction (e.g., the Z-direction). The fixing part FP secures a lower end of the elastic structure 130 to the lower plate 110. The nut 140 is threadedly engaged with the elastic structure 130. The nut 140 abuts against the top surface 120a of the upper plate 120. The nut 140 is configured to rotate relative to a rotation axis parallel to the direction (e.g., the Z-direction). The sleeve 150 sleeves the elastic structure 130. The sleeve 150 includes a sleeve main body 152 and a shoulder portion 154. The shoulder portion 154 is located at an end of the sleeve main body 152. In some embodiments, along the Z-direction, an outer diameter of the shoulder portion 154 is greater than an outer diameter of the sleeve main body 152. The sealing washer 160 is disposed between the nut 140 and the upper plate 120.

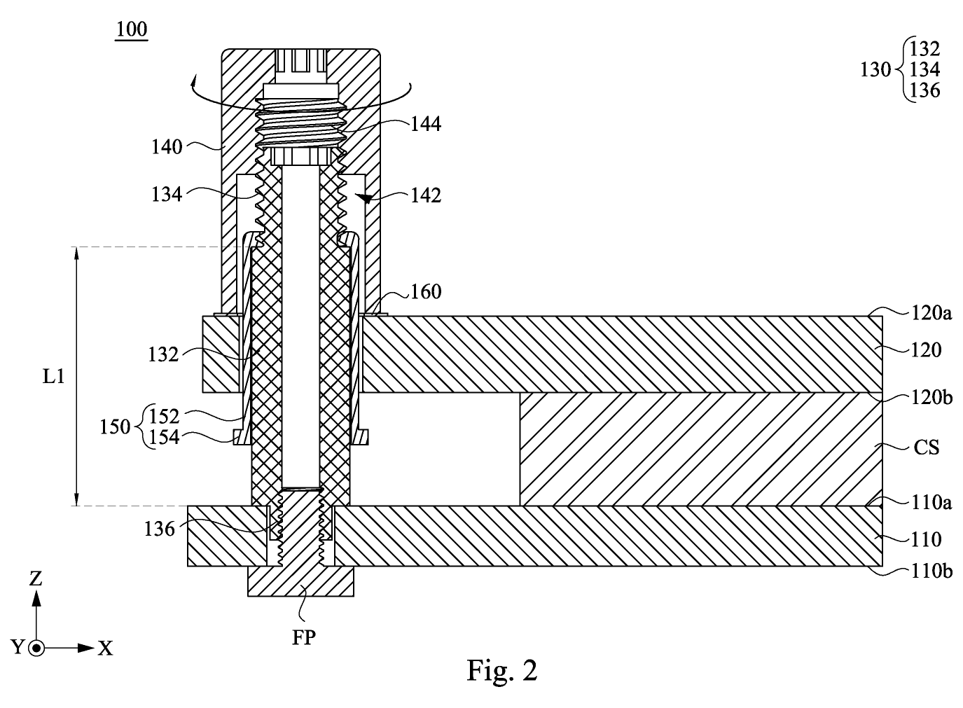

Reference is made to FIG. 2. FIG. 2 is a cross-sectional view of the fixing structure 100 in accordance with an embodiment of the present disclosure. As shown in FIG. 2, in this embodiment, the core structure CS contacts the top surface 110a of the lower plate 110 and the bottom surface 120b of the upper plate 120. The elastic structure 130 passes through the upper plate 120. The elastic structure 130 includes an elastic portion 132, a bolt portion 134, and a screwing portion 136. The elastic portion 132 elastically stretches and compresses (i.e., elastically expands and elastically contracts) along a direction (e.g., the Z-direction). The bolt portion 134 is connected to an end of the elastic portion 132. The screwing portion 136 is connected to the other end of the elastic portion 132. The bolt portion 134 is threadedly engaged with the nut 140. The screwing portion 136 is fixed to the lower plate 110 and remains stationary relative to the lower plate 110. The fixing part FP is threadedly engaged with the screwing portion 136. In some embodiments, the bolt portion 134 is located at an upper end of the elastic portion 132, and the screwing portion 136 is located at a lower end of the elastic portion 132. The nut 140 has an accommodating space 142 and includes an inner thread 144. The accommodating space 142 accommodates the elastic portion 132. The inner thread 144 of the nut 140 is threadedly engaged with the bolt portion 134 of the elastic structure 130. As shown in FIG. 2, the sleeve main body 152 of the sleeve 150 passes through the upper plate 120, and the shoulder portion 154 of the sleeve 150 is located between the lower plate 110 and the upper plate 120.

In a usage scenario, when the nut 140 rotates along a rotation axis parallel to a direction (e.g., the Z-direction), the nut 140 continues to abut against the top surface 120a of the upper plate 120, thereby driving the upper plate 120 to move toward the lower plate 110. In some embodiments, in a top view, when the nut 140 rotates in a clockwise direction along the rotation axis parallel to the direction (e.g., the Z-direction), the nut 140 drives the upper plate 120 to move toward the lower plate 110, and the elastic portion 132 elastically stretches. Conversely, when the nut 140 rotates in a counterclockwise direction along the rotation axis parallel to the direction (e.g., the Z-direction), the nut 140 drives the upper plate 120 to move away from the lower plate 110, and the elastic portion 132 elastically compresses. When the nut 140 continues to rotate to drive the upper plate 120 toward the lower plate 110 until the lower plate 110 and the upper plate 120 jointly clamp the core structure CS, the elastic portion 132 has a length L1.

As shown in FIG. 2, in some embodiments, the bolt portion 134 includes an outer thread. The outer thread of the bolt portion 134 is threadedly engaged with the inner thread 144 of the nut 140.

As shown in FIG. 2, in some embodiments, the screwing portion 136 includes an inner thread, and the fixing part FP includes an outer thread. The inner thread of the screwing portion 136 is threadedly engaged with the outer thread of the fixing part FP.

In some embodiments, the elastic portion 132 may include, for example, a material having ductility. In some embodiments, the elastic portion 132 includes hollowed portions formed on its surface, so that the solid portions of the elastic portion 132 possess an ability to stretch and compress.

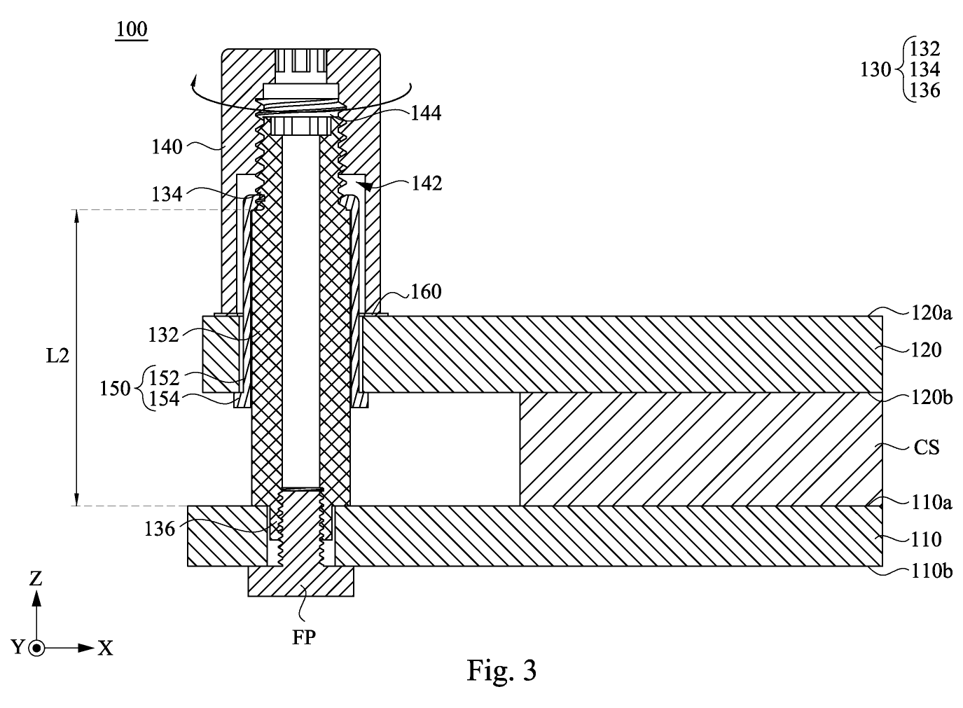

Reference is made to FIG. 3. FIG. 3 is a cross-sectional view of the fixing structure 100 in accordance with an embodiment of the present disclosure. As shown in FIG. 3, in this embodiment, the nut 140 continues to rotate along a rotation axis parallel to a direction (e.g., the Z-direction), such that a distance between the lower plate 110 and the upper plate 120 clamping the core structure CS is substantially maintained constant. As the nut 140 continues to rotate along the rotation axis parallel to the direction (e.g., the Z-direction), the inner thread 144 of the nut 140 is threadedly engaged with the bolt portion 134, such that the bolt portion 134 moves away from the lower plate 110, thereby driving the elastic portion 132 to elastically stretch along a direction (e.g., the Z-direction). Additionally, the sleeve 150 is disposed on the elastic structure 130 and moves away from the lower plate 110 along with the elastic stretching of the elastic portion 132, such that the shoulder portion 154 abuts against the bottom surface 120b of the upper plate 120. In some embodiments, an upper edge of the sleeve 150 is embedded with the bolt portion 134. Alternatively, in some embodiments, the sleeve 150 is suspended from a periphery of a top portion of the elastic portion 132.

In a usage scenario, when the nut 140 rotates along a rotation axis parallel to a direction (e.g., the Z-direction), the lower plate 110 and the upper plate 120 are spaced apart at a constant distance. The nut 140, which is threadedly engaged with the bolt portion 134, continues to provide a downward force to the upper plate 120 and thereby drives the sleeve 150 to move upward. In some embodiments, in a top view, when the nut 140 rotates in a clockwise direction along the rotation axis parallel to the direction (e.g., the Z-direction), the elastic portion 132 elastically stretches, and the sleeve 150 moves away from the lower plate 110. Conversely, when the nut 140 rotates in a counterclockwise direction along the rotation axis parallel to the direction (e.g., the Z-direction), the elastic portion 132 elastically compresses, and the sleeve 150 moves toward the lower plate 110. When the nut 140 rotates and continues to drive the sleeve 150 to move away from the lower plate 110 until the shoulder portion 154 abuts against the bottom surface 120b of the upper plate 120, the elastic portion 132 has a length L2. In some embodiments, the length L2 is greater than the length L1.

By the aforementioned structural configuration, when the nut 140 rotates relative to a rotation axis parallel to a direction (e.g., the Z-direction) and the lower plate 110 and the upper plate 120 have not yet simultaneously contacted the core structure CS, the nut 140 drives the upper plate 120 to move toward the lower plate 110. Next, as shown in FIG. 2, when the nut 140 continues to rotate along the rotation axis parallel to the direction (e.g., the Z-direction) until the lower plate 110 and the upper plate 120 simultaneously contact the core structure CS, the elastic portion 132 does not stretch but has the length L1. Next, as shown in FIG. 3, when the nut 140 further rotates along the rotation axis parallel to the direction (e.g., the Z-direction) such that the shoulder portion 154 abuts against the bottom surface 120b of the upper plate 120, the elastic portion 132 elastically stretches and has the length L2, and the upper plate 120 remains stationary relative to the lower plate 110. This ensures that the lower plate 110 and the upper plate 120 do not deform due to over-tightening and prevents damage to the core structure CS due to over-tightening.

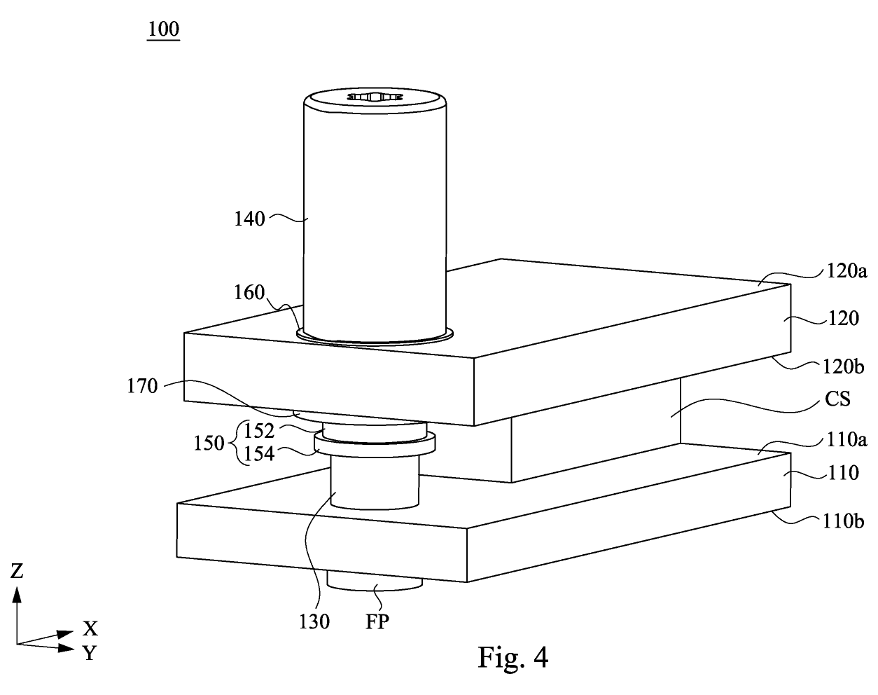

Reference is made to FIG. 4. FIG. 4 is a perspective view of the fixing structure 100 in accordance with an embodiment of the present disclosure. The structural configuration of the fixing structure 100 in FIG. 4 is generally similar to that of FIG. 1, with the primary difference being that the fixing structure 100 in FIG. 4 further includes a spacing washer 170. As shown in FIG. 4, in this embodiment, the spacing washer 170 is located between the upper plate 120 and the shoulder portion 154 of the sleeve 150. The spacing washer 170 surrounds the sleeve main body 152 of the sleeve 150. For simplicity, further structural configuration of the fixing structure 100 in FIG. 4 will not be redundantly described.

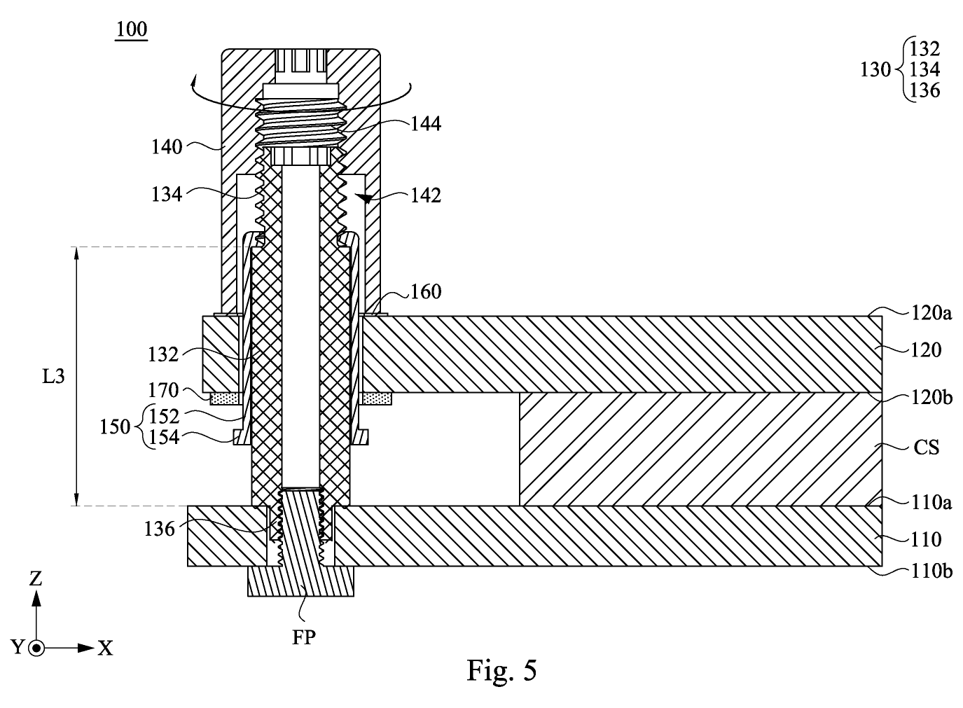

Reference is made to FIG. 5. FIG. 5 is a cross-sectional view of the fixing structure 100 in accordance with an embodiment of the present disclosure. As shown in FIG. 5, in this embodiment, the spacing washer 170 is configured to separate the upper plate 120 from the shoulder portion 154. Specifically, when the core structure CS has a greater height along a direction (e.g., the Z-direction), the spacing washer 170 can be disposed between the upper plate 120 and the shoulder portion 154 to achieve the effect of maintaining a constant amount of deformation of the elastic portion 132. That is, the greater the height of the core structure CS, the greater the number or thickness of the spacing washers 170 that may be disposed between the upper plate 120 and the shoulder portion 154 to keep the amount of deformation of the elastic portion 132 constant.

In a usage scenario, when the nut 140 rotates along a rotation axis parallel to a direction (e.g., the Z-direction), the nut 140 continues to abut against the top surface 120a of the upper plate 120, thereby driving the upper plate 120 to move toward the lower plate 110. When the nut 140 rotates and continues to drive the upper plate 120 to move toward the lower plate 110 until the lower plate 110 and the upper plate 120 jointly clamp the core structure CS, the elastic portion 132 has a length L3, and the spacing washer 170 is freely movable between the upper plate 120 and the shoulder portion 154.

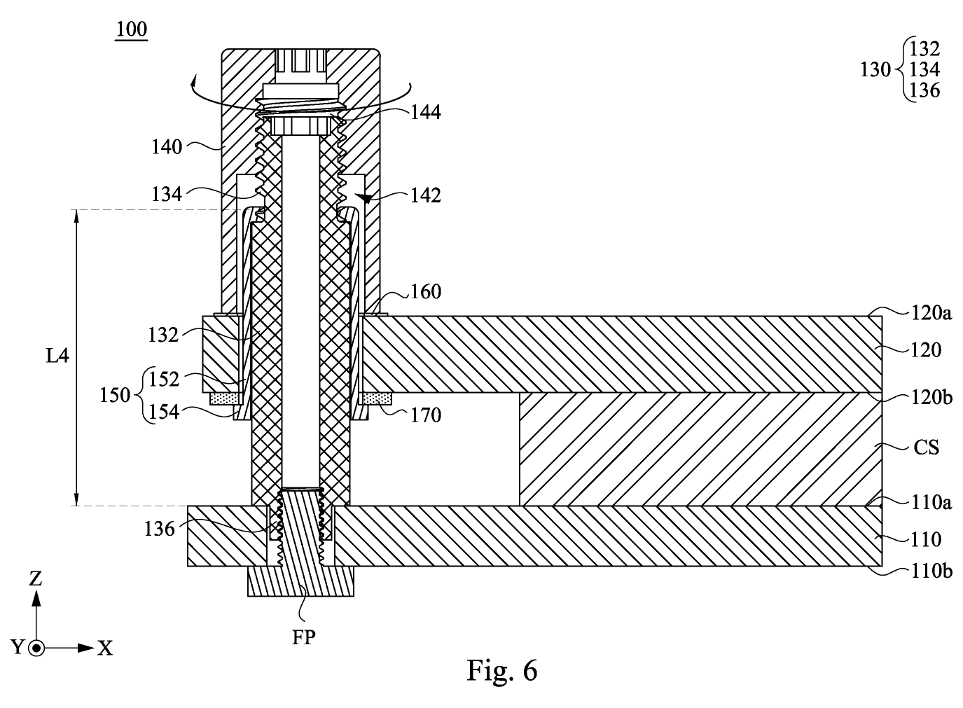

Reference is made to FIG. 6. FIG. 6 is a cross-sectional view of the fixing structure 100 in accordance with an embodiment of the present disclosure. As shown in FIG. 6, in this embodiment, the nut 140 continues to rotate along a rotation axis parallel to a direction (e.g., the Z-direction), such that a distance between the lower plate 110 and the upper plate 120 clamping the core structure CS is substantially maintained constant. As the nut 140 continues to rotate along the rotation axis parallel to a direction (e.g., the Z-direction), the inner thread 144 of the nut 140 is threadedly engaged with the bolt portion 134, such that the bolt portion 134 to move away from the lower plate 110, thereby driving the elastic portion 132 to elastically stretch along a direction (e.g., the Z-direction). Additionally, the sleeve 150 is disposed on the elastic structure 130 and moves away from the lower plate 110 along with the stretching of the elastic portion 132, such that the shoulder portion 154 abuts against the spacing washer 170 and the spacing washer 170 contacts both the upper plate 120 and the shoulder portion 154 simultaneously.

In a usage scenario, when the nut 140 rotates along a rotation axis parallel to a direction (e.g., the Z-direction), the lower plate 110 and the upper plate 120 are spaced apart at a constant distance. The nut 140, which is threadedly engaged with the bolt portion 134, continues to provide a downward force to the upper plate 120 and thereby drives the sleeve 150 to move upward. When the nut 140 continues to rotate and drives the sleeve 150 to move away from the lower plate 110 until the shoulder portion 154 abuts against the spacing washer 170, the elastic portion 132 has a length L4. In some embodiments, the length L4 is greater than the length L3.

By the aforementioned structural configuration, when the nut 140 rotates relative to a rotation axis parallel to a direction (e.g., the Z-direction) and the lower plate 110 and the upper plate 120 have not yet simultaneously contacted the core structure CS, the nut 140 drives the upper plate 120 to move toward the lower plate 110. Next, as shown in FIG. 5, when the nut 140 continues to rotate along the rotation axis parallel to the direction (e.g., the Z-direction) until the lower plate 110 and the upper plate 120 simultaneously contact the core structure CS, the elastic portion 132 does not stretch but has a length L3. Next, as shown in FIG. 6, when the nut 140 further rotates along the rotation axis parallel to the direction (e.g., the Z-direction) such that the spacing washer 170 contacts the bottom surface 120b of the upper plate 120 and the shoulder portion 154, the elastic portion 132 elastically stretches and has a length L4, and the upper plate 120 remains stationary relative to the lower plate 110. This ensures that, even if the core structure CS has different heights, the travel of the sleeve 150 and the amount of elastic deformation of the elastic portion 132 can be maintained constant, thereby achieving the effect of maintenance and prolonging service life.

Hereinafter, the structure and function of each component included in a fixing structure 200 of this embodiment and the connection relationship between the components will be described in detail.

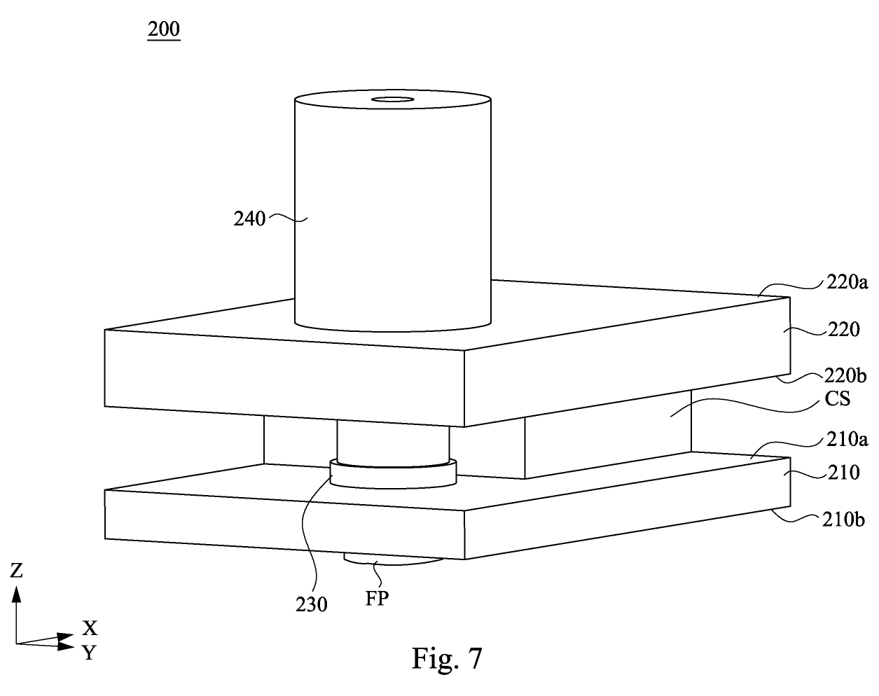

Reference is made to FIG. 7. FIG. 7 is a perspective view of a fixing structure 200 in accordance with an embodiment of the present disclosure. As shown in FIG. 7, in this embodiment, the fixing structure 200 is configured to fix a core structure CS. The fixing structure 200 includes a lower plate 210, an upper plate 220, an elastic structure 230, a nut 240, and a fixing part FP. The lower plate 210 has a top surface 210a and a bottom surface 210b. The upper plate 220 has a top surface 220a and a bottom surface 220b. The upper plate 220 is located over the lower plate 210. The core structure CS is located between the upper plate 220 and the lower plate 210. The elastic structure 230 is connected between the lower plate 210 and the upper plate 220. The elastic structure 230 is configured to elastically stretch and compress along a direction (e.g., the Z-direction). The fixing part FP secures a lower end of the elastic structure 230 to the lower plate 210. The nut 240 is threadedly engaged with the elastic structure 230. The nut 240 abuts against the top surface 220a of the upper plate 220. The nut 240 is configured to rotate relative to a rotation axis parallel to a direction (e.g., the Z-direction).

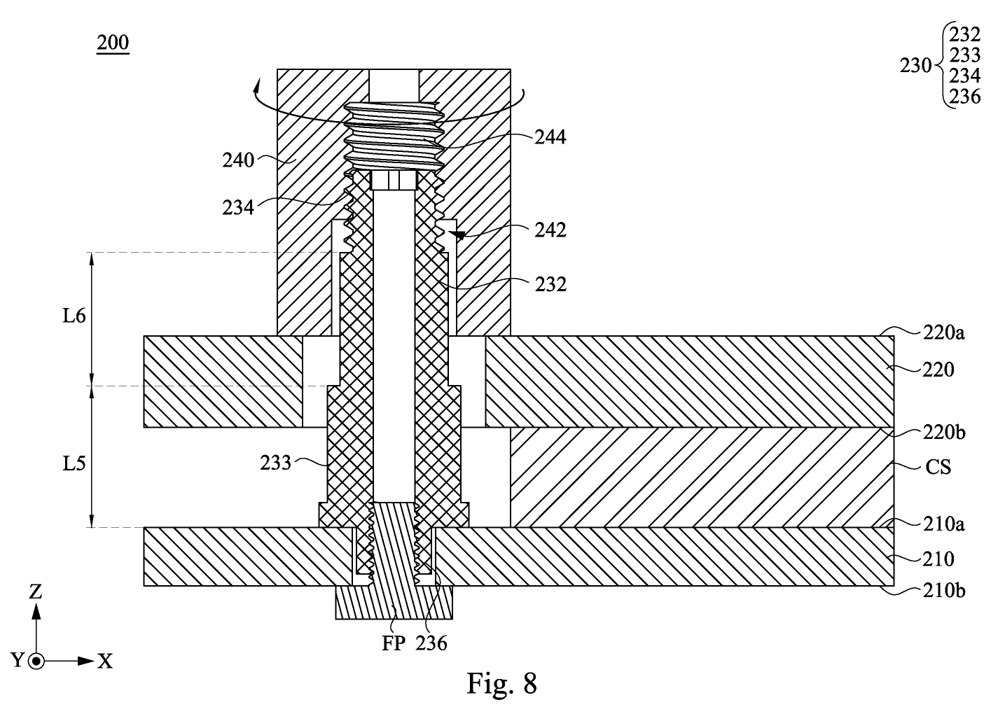

Reference is made to FIG. 8. FIG. 8 is a cross-sectional view of the fixing structure 200 in accordance with an embodiment of the present disclosure. As shown in FIG. 8, in this embodiment, the core structure CS contacts the top surface 210a of the lower plate 210 and the bottom surface 220b of the upper plate 220. The elastic structure 230 passes through the upper plate 220. The elastic structure 230 includes a first elastic portion 232, a second elastic portion 233, a bolt portion 234, and a screwing portion 236. The first elastic portion 232 and the second elastic portion 233 elastically stretch and compress (i.e., elastically expands and elastically contracts) along a direction (e.g., the Z-direction). The second elastic portion 233 is connected to the first elastic portion 232. The bolt port234 ion is connected to the first elastic portion 232. The screwing portion 236 is connected to the second elastic portion 233. The bolt portion 234 is threadedly engaged with the nut 240. The screwing portion 236 is fixed to the lower plate 210 and remains stationary relative to the lower plate 210. The fixing part FP is threadedly engaged with the screwing portion 236. In some embodiments, the bolt portion 234 is located at an upper end of the first elastic portion 232, and the screwing portion 236 is located at a lower end of the second elastic portion 233. The nut 240 has an accommodating space 242 and includes an inner thread 244. The accommodating space 242 accommodates the first elastic portion 232. The inner thread 244 of the nut 240 is threadedly engaged with the bolt portion 234 of the elastic structure 230.

In a usage scenario, when the nut 240 rotates along a rotation axis parallel to a direction (e.g., the Z-direction), the nut 240 continues to abut against the top surface 220a of the upper plate 220, thereby driving the upper plate 220 to move toward the lower plate 210. In some embodiments, in a top view, when the nut 240 rotates in a clockwise direction along a rotation axis parallel to the direction (e.g., the Z-direction), the nut 240 drives the upper plate 220 to move toward the lower plate 210, and the first elastic portion 232 and the second elastic portion 233 elastically stretch simultaneously. Conversely, when the nut 240 rotates in a counterclockwise direction along the rotation axis parallel to the direction (e.g., Z-direction), the nut 240 drives the upper plate 220 to move away from the lower plate 210, and the first elastic portion 232 and the second elastic portion 233 elastically compress simultaneously. When the nut 240 continues to rotate to drive the upper plate 220 toward the lower plate 210 until the lower plate 210 and the upper plate 220 jointly clamp the core structure CS, the second elastic portion 233 has a length L5 and the first elastic portion 232 has a length L6.

As shown in FIG. 8, in some embodiments, the bolt portion 234 includes an outer thread. The outer thread of the bolt portion 234 is threadedly engaged with the inner thread 244 of the nut 240.

As shown in FIG. 8, in some embodiments, the screwing portion 236 includes an inner thread, and the fixing part FP includes an outer thread. The inner thread of the screwing portion 236 is threadedly engaged with the outer thread of the fixing part FP.

In some embodiments, the first elastic portion 232 and the second elastic portion 233 may include, for example, a material having ductility. In some embodiments, the first elastic portion 232 and the second elastic portion 233 include hollowed portions on their surfaces, so that the solid portions of the first elastic portion 232 and the second elastic portion 233 possess an ability to stretch and compress.

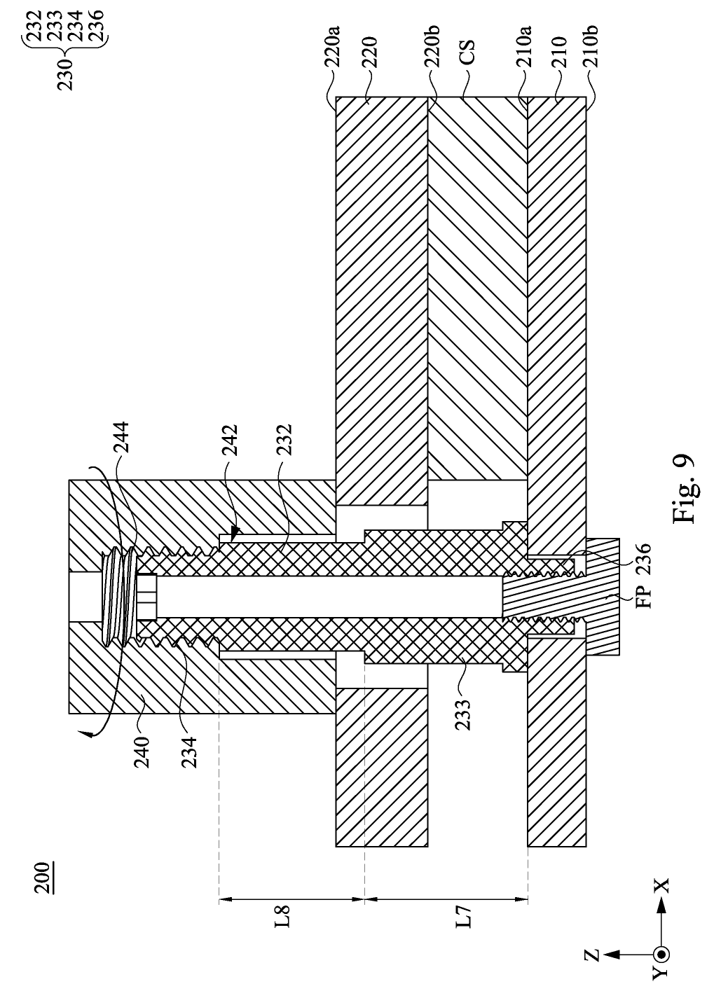

Reference is made to FIG. 9. FIG. 9 is a cross-sectional view of the fixing structure 200 in accordance with an embodiment of the present disclosure. As shown in FIG. 9, in this embodiment, the nut 240 continues to rotate along a rotation axis parallel to a direction (e.g., the Z-direction), such that a distance between the lower plate 210 and the upper plate 220 clamping the core structure CS is substantially maintained constant. As the nut 240 continues to rotate along the rotation axis parallel to the direction (e.g., the Z-direction), the inner thread 244 of the nut 240 is threadedly engaged with the bolt portion 234, such that the bolt portion 234 moves away from the lower plate 210, thereby simultaneously driving the first elastic portion 232 and the second elastic portion 233 to elastically stretch along a direction (e.g., the Z-direction).

In a usage scenario, when the nut 240 rotates along a rotation axis parallel to a direction (e.g., the Z-direction), the lower plate 210 and the upper plate 220 are spaced apart at a constant distance. The nut 240, which is threadedly engaged with the bolt portion 234, continues to provide a downward force to the upper plate 220. In some embodiments, in a top view, when the nut 240 rotates in a clockwise direction along the rotation axis parallel to the direction (e.g., the Z-direction), the first elastic portion 232 and the second elastic portion 233 elastically stretch simultaneously. Conversely, when the nut 240 rotates in a counterclockwise direction along the rotation axis parallel to the direction (e.g., the Z-direction), the first elastic portion 232 and the second elastic portion 233 elastically compress simultaneously. When the nut 240 continues to rotate such that the first elastic portion 232 abuts against an end of the accommodating space 242 close to the inner thread 244, the second elastic portion 233 has a length L7, and the first elastic portion 232 has a length L8. In some embodiments, the length L7 is greater than the length L5, and the length L8 is greater than the length L6.

By the aforementioned structural configuration, when the nut 240 rotates relative to a rotation axis parallel to a direction (e.g., the Z-direction) and the lower plate 210 and the upper plate 220 have not yet simultaneously contacted the core structure CS, the nut 240 drives the upper plate 220 to move toward the lower plate 210. Next, as shown in FIG. 8, when the nut 240 continues to rotate until the lower plate 210 and the upper plate 220 simultaneously contact the core structure CS, the first elastic portion 232 and the second elastic portion 233 do not stretch but respectively have the length L6 and the length L5. Next, as shown in FIG. 9, when the nut 240 further rotates along the rotation axis parallel to the direction (e.g., the Z-direction) such that the first elastic portion 232 abuts against an end of the accommodating space 242 close to the inner thread 244, the first elastic portion 232 and the second elastic portion 233 elastically stretch and respectively have the length L8 and the length L7, and the upper plate 220 remains stationary relative to the lower plate 210. This ensures that the lower plate 210 and the upper plate 220 do not deform due to over-tightening and prevents damage to the core structure CS due to over-tightening.

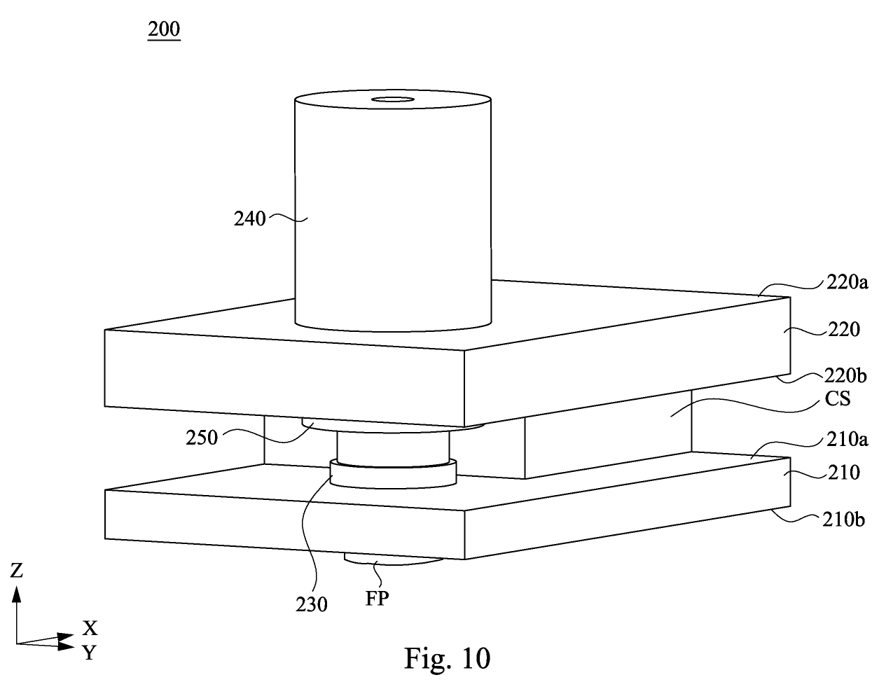

Reference is made to FIG. 10. FIG. 10 is a perspective view of the fixing structure 200 in accordance with an embodiment of the present disclosure. The structural configuration of the fixing structure 200 shown in FIG. 10 is generally similar to that shown in FIG. 7, with the difference being that the fixing structure 200 in FIG. 10 further includes a sleeve 250. As shown in FIG. 10, in this embodiment, the sleeve 250 sleeves the elastic structure 230. For simplicity, further structural configuration of the fixing structure 200 in FIG. 10 will not be redundantly described.

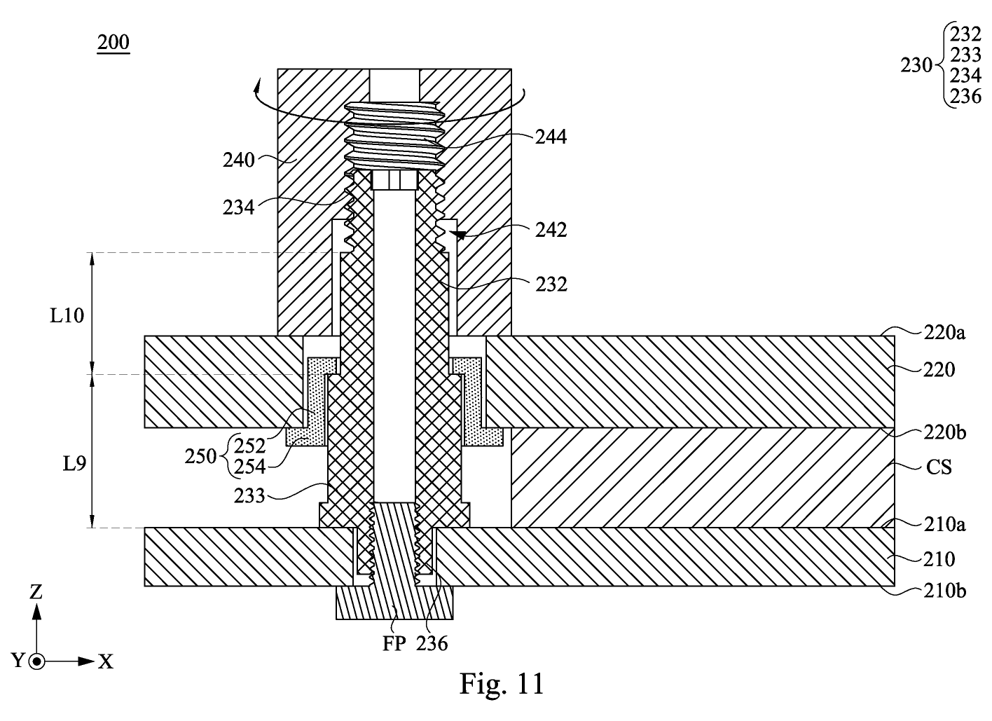

Reference is made to FIG. 11. FIG. 11 is a cross-sectional view of the fixing structure 200 in accordance with an embodiment of the present disclosure. As shown in FIG. 11, in this embodiment, the nut 240 includes an accommodating space 242 that accommodates the first elastic portion 232. The sleeve 250 sleeves the second elastic portion 233. The sleeve 250 includes a sleeve main body 252 and a shoulder portion 254. The shoulder portion 254 is located at an end of the sleeve main body 252. In some embodiments, along the Z-direction, an outer diameter of the shoulder portion 254 is greater than an outer diameter of the sleeve main body 252. The sleeve main body 252 of the sleeve 250 passes through the upper plate 220, and the shoulder portion 254 of the sleeve 250 is located between the lower plate 210 and the upper plate 220. The sleeve 250 moves away from the lower plate 210 as the second elastic portion 233 elastically stretches, such that the shoulder portion 254 abuts against the bottom surface 220b of the upper plate 220. In some embodiments, the sleeve 250 is suspended from a periphery of a top portion of the second elastic portion 233.

In a usage scenario, when the nut 240 rotates along a rotation axis parallel to a direction (e.g., the Z-direction), the nut 240 continues to abut against the top surface 120a of the upper plate 120, thereby driving the upper plate 220 to move toward the lower plate 210. When the nut 240 continues to rotate and drives the upper plate 220 toward the lower plate 210 until the lower plate 210 and the upper plate 220 jointly clamp the core structure CS, the shoulder portion 254 is movable between the upper plate 220 and the lower plate 210. Next, when the nut 240 further rotates along the rotation axis parallel to the direction (e.g., the Z-direction), the first elastic portion 232 and the second elastic portion 233 elastically stretch and the sleeve 250 moves away from the lower plate 210. Next, when the nut 240 rotates and continues to drive the sleeve 250 to move away from the lower plate 210 until the shoulder portion 254 abuts against the bottom surface 220b of the upper plate 220, the second elastic portion 233 has the length L10, and the first elastic portion 232 has the length L9.

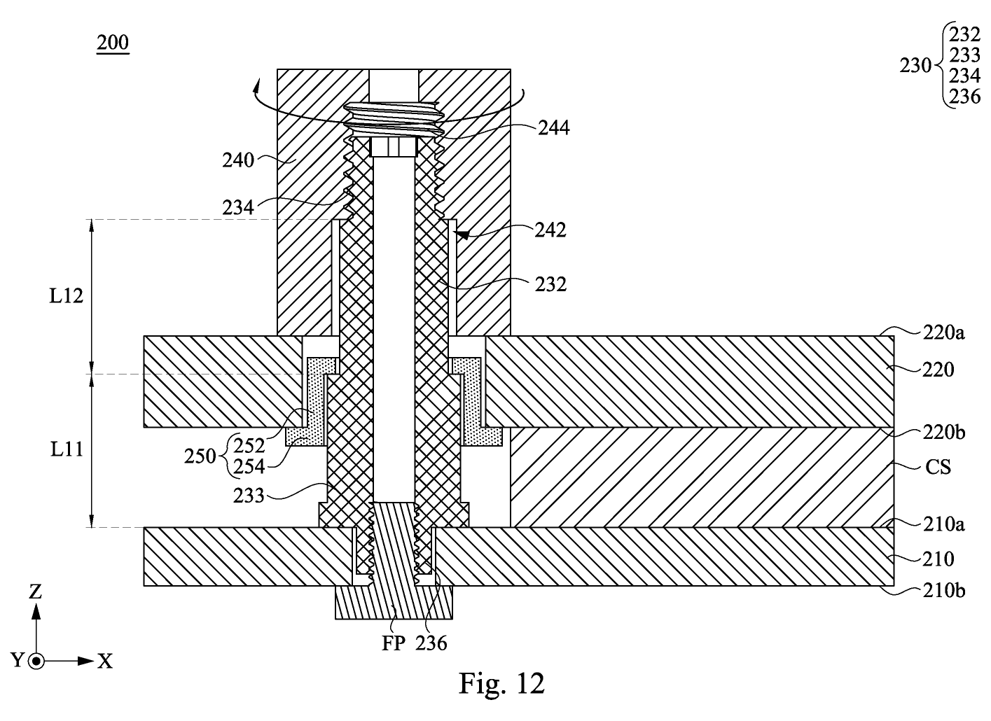

Reference is made to FIG. 12. FIG. 12 is a cross-sectional view of the fixing structure 200 in accordance with an embodiment of the present disclosure. As shown in FIG. 12, in this embodiment, the nut 240 continues to rotate along a rotation axis parallel to a direction (e.g., the Z-direction), such that the distance between the lower plate 210 and the upper plate 220 clamping the core structure CS is substantially maintained constant. As the nut 240 continues to rotate along a rotation axis parallel to a direction (e.g., the Z-direction), the inner thread 244 of the nut 240 is threadedly engaged with the bolt portion 234 such that the bolt portion 234 moves away from the lower plate 210, thereby driving the first elastic portion 232 to elastically stretch along a direction (e.g., the Z-direction), while the second elastic portion 233 does not elastically stretch due to restriction by the sleeve 250. Specifically, since the shoulder portion 254 of the sleeve 250 abuts against the bottom surface 220b of the upper plate 220, the sleeve main body 252 limits the elastic stretching of the second elastic portion 233.

In a usage scenario, when the nut 240 rotates along a rotation axis parallel to a direction (e.g., the Z-direction), the lower plate 210 and the upper plate 220 are spaced apart at a constant distance. The nut 240, threadedly engaged with the bolt portion 234, continues to provide a downward force to the upper plate 220. When the nut 240 continues to rotate such that the first elastic portion 232 abuts against an end of the accommodating space 242 close to the inner thread 244, the second elastic portion 233 has a length L11, and the first elastic portion 232 has a length L12. In some embodiments, the length L12 is greater than the length L10. In some embodiments, the length L9 is equal to the length L11.

By the aforementioned structural configuration, when the nut 240 rotates relative to a rotation axis parallel to a direction (e.g., the Z-direction) and the lower plate 210 and the upper plate 220 have not yet simultaneously contacted the core structure CS, the nut 240 drives the upper plate 220 to move toward the lower plate 210. Next, when the nut 240 continues to rotate relative to a rotation axis parallel to a direction (e.g., the Z-direction) until the lower plate 210 and the upper plate 220 simultaneously contact the core structure CS, neither the first elastic portion 232 nor the second elastic portion 233 elastically stretch. Next, when the nut 240 continues to rotate relative to a rotation axis parallel to a direction (e.g., the Z-direction), the first elastic portion 232 and the second elastic portion 233 elastically stretch simultaneously and the sleeve 250 moves toward the upper plate 220. Next, as shown in FIG. 11, when the nut 240 continues to rotate relative to a rotation axis parallel to a direction (e.g., the Z-direction) until the shoulder portion 254 abuts against the bottom surface 220b of the upper plate 220, the first elastic portion 232 elastically stretches, while the second elastic portion 233 remains stationary. Next, as shown in FIG. 12, when the nut 240 continues to rotate relative to a rotation axis parallel to a direction (e.g., the Z-direction) such that the first elastic portion 232 abuts against an end of the accommodating space 242 close to the inner thread 244, the upper plate 220 remains stationary relative to the lower plate 210. This ensures that the lower plate 210 and the upper plate 220 do not deform due to over-tightening and prevents damage to the core structure CS due to over-tightening. Furthermore, it ensures that the elastic stretching and compressing amount of the second elastic portion 233 equipped with the sleeve 250 remains constant, thereby achieving the effect of maintenance and extending service life.

From the above detailed description of the specific embodiments of the present disclosure, it is clearly evident that, in the fixing structure of the present disclosure, since the nut is threadedly engaged with the bolt portion of the elastic structure and abuts against the top surface of the upper plate, the rotation of the nut relative to the bolt portion can drive the upper plate to move toward the lower plate, thereby allowing the upper plate and the lower plate to clamp the core structure. In the fixing structure of the present disclosure, since the elastic structure includes an elastic portion that elastically stretches along a direction, the elastic portion elastically stretches along the direction after the nut rotates relative to the bolt portion such that the upper plate and the lower plate clamp the core structure, thereby preventing deformation of the upper plate and the lower plate and damage to the core structure caused by over-tightening. In the fixing structure of the present disclosure, since the sleeve sleeves the elastic portion, the sleeve includes a sleeve main body and a shoulder portion located at an end of the sleeve main body, and the screwing portion of the elastic structure is fixed to the lower plate, the sleeve moves toward the nut along with the stretching of the elastic portion and the elastic portion stops stretching when the shoulder portion abuts against the bottom surface of the upper plate. In the fixing structure of the present disclosure, since the spacing washer is disposed between the shoulder portion and the upper plate, when the core structure has a greater length along the direction, more spacing washers may be disposed between the shoulder portion and the upper plate such that a constant amount of elastic stretching of the elastic portion can be maintained, thereby achieving the effect of prolonging the service life of the elastic structure. Overall, the fixing structure of the present disclosure can be used to fix core structures of various sizes between the upper plate and the lower plate, prevent deformation and damage caused by over-tightening, and extend the service life of the elastic structure.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A fixing structure, comprising:
a lower plate;
an upper plate located over the lower plate;
an elastic structure running through the upper plate, and the elastic structure comprising an elastic portion, a bolt portion connected to an end of the elastic portion, and a screwing portion connected to the other end of the elastic portion, wherein the elastic portion elastically stretches and compresses along a direction, and the screwing portion is fixed to the lower plate and remains stationary relative to the lower plate; and
a nut threadedly engaged with the bolt portion and abutting against a top surface of the upper plate,
wherein the nut rotates relative to a rotation axis parallel to the direction and drives the upper plate to move toward the lower plate, and the elastic portion elastically stretches along the direction.

2. The fixing structure of claim 1, wherein the nut rotates relative to the rotation axis parallel to the direction and drives the upper plate to move away from the lower plate, and the elastic portion elastically compresses along the direction.

3. The fixing structure of claim 1, further comprising a fixing part threadedly engaged with the screwing portion.

4. The fixing structure of claim 1, further comprising a sleeve sleeving the elastic structure, wherein the sleeve comprises a sleeve main body passing through the upper plate and a shoulder portion located at an end of the sleeve main body.

5. The fixing structure of claim 4, wherein the upper plate remains stationary relative to the lower plate when the nut rotates relative to the rotation axis parallel to the direction, such that the shoulder portion abuts against a bottom surface of the upper plate.

6. The fixing structure of claim 4, further comprising a spacing washer disposed between the upper plate and the shoulder portion.

7. The fixing structure of claim 6, wherein the upper plate remains stationary relative to the lower plate when the nut rotates relative to the rotation axis parallel to the direction, such that the spacing washer contacts a bottom surface of the upper plate and the shoulder portion.

8. The fixing structure of claim 1, wherein the elastic portion comprises a first elastic portion and a second elastic portion connected to the first elastic portion, the first elastic portion is connected to the bolt portion, and the second elastic portion is connected to the screwing portion.

9. The fixing structure of claim 8, wherein the nut comprises an inner thread threadedly engaged with the bolt portion and has an accommodating space accommodating the elastic portion.

10. The fixing structure of claim 9, wherein the upper plate remains stationary relative to the lower plate when the nut rotates relative to the rotation axis parallel to the direction, such that the first elastic portion abuts against an end of the accommodating space close to the inner thread.

11. The fixing structure of claim 8, wherein the first elastic portion and the second elastic portion elastically stretch simultaneously when the nut rotates relative to the rotation axis parallel to the direction and drives the upper plate to move toward the lower plate.

12. The fixing structure of claim 8, further comprising a sleeve sleeving the second elastic portion, the sleeve comprising a sleeve main body passing through the upper plate and a shoulder portion located at an end of the sleeve main body.

13. The fixing structure of claim 12, wherein the nut comprises an inner thread threadedly engaged with the bolt portion and has an accommodating space accommodating the first elastic portion.

14. The fixing structure of claim 13, wherein the upper plate remains stationary relative to the lower plate when the nut rotates relative to the rotation axis parallel to the direction such that the first elastic portion abuts against an end of the accommodating space close to the inner thread.

15. The fixing structure of claim 13, wherein the first elastic portion elastically stretches and the second elastic portion remains stationary when the nut rotates relative to the rotation axis parallel to the direction and the shoulder portion abuts against a bottom surface of the upper plate.

16. The fixing structure of claim 12, wherein the first elastic portion and the second elastic portion elastically stretch simultaneously and the sleeve moves toward the upper plate when the nut rotates relative to the rotation axis parallel to the direction.

17. A fixing structure: comprising:
a lower plate;
an upper plate located over the lower plate;
a core structure located between the upper plate and the lower plate;
an elastic structure running through the upper plate, and the elastic structure comprising an elastic portion, a bolt portion connected to an end of the elastic portion, and a screwing portion connected to the other end of the elastic portion, wherein the elastic portion elastically stretches and compresses along a direction, and the screwing portion is fixed to the lower plate and remains stationary relative to the lower plate; and
a nut threadedly engaged with the bolt portion and abutting against a top surface of the upper plate,
wherein the nut rotates relative to a rotation axis parallel to the direction and drives the upper plate to move toward the lower plate, and the elastic portion elastically stretches along the direction.

18. The fixing structure of claim 17, further comprising a sleeve sleeving the elastic structure, wherein the sleeve comprises a sleeve main body passing through the upper plate and a shoulder portion located at an end of the sleeve main body.

19. The fixing structure of claim 17, wherein the elastic portion comprises a first elastic portion and a second elastic portion connected to the first elastic portion, the first elastic portion is connected to the bolt portion, and the second elastic portion is connected to the screwing portion.

20. The fixing structure of claim 19, further comprising a sleeve sleeving the second elastic portion, the sleeve comprising a sleeve main body passing through the upper plate and a shoulder portion located at an end of the sleeve main body.
